(19) United States
(12) Patent Application Publication
(10) Pub. No.: US 2005/0183257 A1
(43) Pub. Date: Aug. 25, 2005

(54) Arrangement for sealingly and releasably connecting two workpieces

(76) Inventor: Gerhard Kathrein, Jenbach (AT)

Correspondence Address: Mark D. Lorusso;Lorusso, Loud & Kelly LLP, Suite 312, 15 Rye Street, Portsmouth, NH, 03801, US

(21) Appl. No.: 11/003,756

(22) Filed: Dec. 2, 2004

(30) Foreign Application Priority Data
Dec. 2, 2003 (AT) A 1924/2003

(51) Int. Cl. B23P 11/02; B23Q 3/00

(52) U.S. Cl. 29/464; 29/450

(57) ABSTRACT

An arrangement for sealingly and releasably connecting a first workpiece to a second workpiece, in particular two flanges, wherein each workpiece (1, 2) has at least one sealing surface (7a, 7b), wherein the first workpiece (1) has at least one guide projection (5) by which the sealing surfaces (7a, 7b) of the two workpieces (1, 2) can be pressed together by way of at least one inclined surface (8) in the assembly procedure.

The present invention relates to an arrangement for sealingly and releasably connecting a first workpiece to a second workpiece, in particular two flanges, wherein each workpiece has at least one sealing surface, and a method of sealingly and releasably connecting same.

The state of the art discloses a large number of arrangements which are intended for connecting two workpieces. Described therein are for example solutions for flange connections, in which a sealing means is arranged between the parts to be connected, the sealing means usually being subjected to pressure in such a way until a suitable sealing function is achieved. In the assembly procedure, however, it can happen that the sealing means is sheared off at an edge by virtue of the two parts bearing snugly against each other or by relative displacement of the parts with respect to each other. Other variants in accordance with the state of the art provide solutions which suffer from the disadvantage that they require a comparatively large additional structural space which is necessary for fitting the two parts together. That disadvantage is a hindrance in terms of a compact structure for installations in mechanical engineering technology. A further important criterion is exact positioning of the workpieces relative to each other as, in the event of inaccurate positioning thereof, the requirements for an adequate sealing effect cannot be satisfied due to remaining air gaps. The state of the art in part satisfies those criteria only at disproportionately high cost and at high technical resources respectively.

It is therefore the object of the present invention to propose an inexpensive and simple solution for sealingly and releasably connecting two workpieces, of the kind set forth in the opening part of this specification, which avoids the above-stated disadvantages of the state of the art.

According to the invention that is achieved in that the first workpiece has at least one guide projection by which the sealing surfaces of the two workpieces can be pressed together by way of at least one inclined surface in the assembly procedure.

By virtue of the provision or formation of at least one such guide projection, in the assembly procedure the two sealing surfaces are pressed together until an adequate sealing function is achieved, by virtue of the second workpiece sliding along the inclined surface provided. Preferably the inclined surface is provided on the guide projection, preferably a cylindrical guide projection having a conical tip. Now, in the assembly procedure, it is advantageously provided that the guide projection engages into an opening—preferably in the form of a blind bore—or engages against an edge of the second workpiece. By virtue of engaging into a corner or engaging against an edge of the second workpiece at the provided inclined surface on the guide projection, the two workpieces are pushed together so that therefore the sealing surfaces of the two workpieces are also pressed against each other. The cylindrical portion of the guide projection serves to hold the two workpieces in that sealing position, after the pressing operation. In accordance with an advantageous embodiment of the invention it can also be provided that the inclined surface is provided at the opening or at the edge.

In accordance with a preferred embodiment of the present invention it is now provided that a guide device of the first workpiece is arranged parallel to the sealing surface, advantageously being in the form of a cylindrical bar. By virtue of that bar—which is suitably spaced from the sealing surface—the second workpiece can firstly be displaced in the axial direction of the bar and exactly positioned without the sealing means being disadvantageously sheared off by an edge of the first workpiece bearing closely thereagainst. The second workpiece can therefore advantageously be guided in spaced relationship with respect to the sealing surface of the workpiece and can only then be pressed against the sealing surface of the first workpiece by sliding along the at least one inclined surface. In that respect it is advantageously provided that a lateral clearance is arranged between the guide device and the second workpiece, whereby the spacing between the two sealing surfaces is compensated and therefore the sealing surfaces or the sealing means can be optimally subjected to pressure.

The method according to the invention is characterised in that the two workpieces are moved in spaced relationship relative to each other and are pressed together by way of at least one inclined surface transversely with respect to the direction of movement only in the last assembly phase.

Further details and features of the present invention are described in greater detail hereinafter by means of the specific description with reference to the drawings in which:

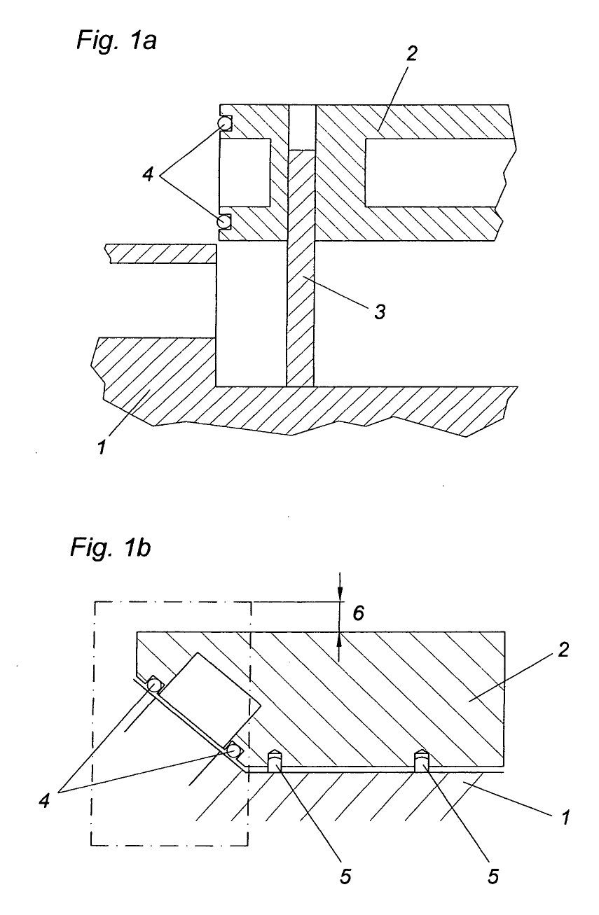

FIGS. 1a and 1b show two variants of a sealed component connection in accordance with the state of the art,

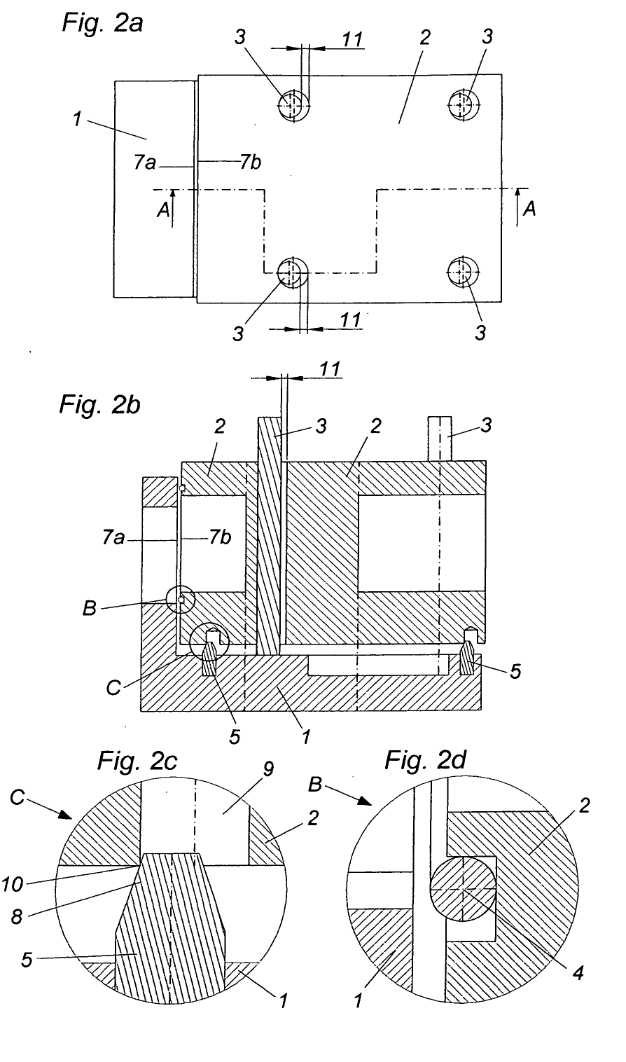

FIG. 2a shows a diagrammatic plan view of the arrangement according to the invention by means of the example of cylinder head assembly,

FIG. 2b shows a diagrammatic view in section taken along line A-A in FIG. 2a in a first assembly step,

FIG. 2c shows a diagrammatic view of the detail C in FIG. 2b,

FIG. 2d shows a diagrammatic view of the detail B in FIG. 2b,

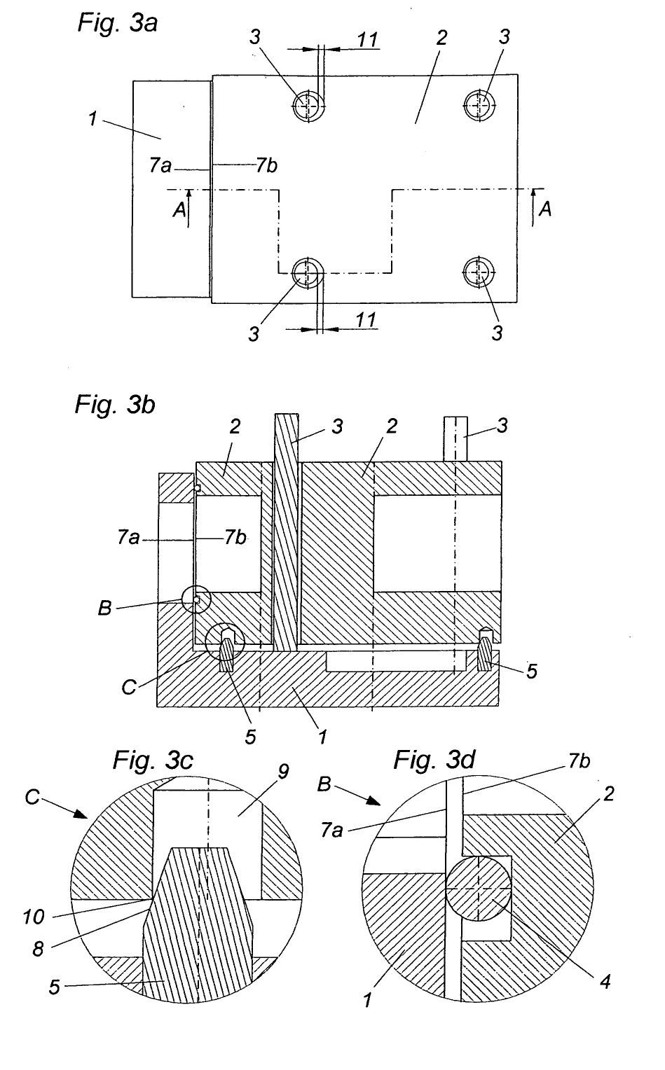

FIGS. 3a, 3b, 3c, 3d and

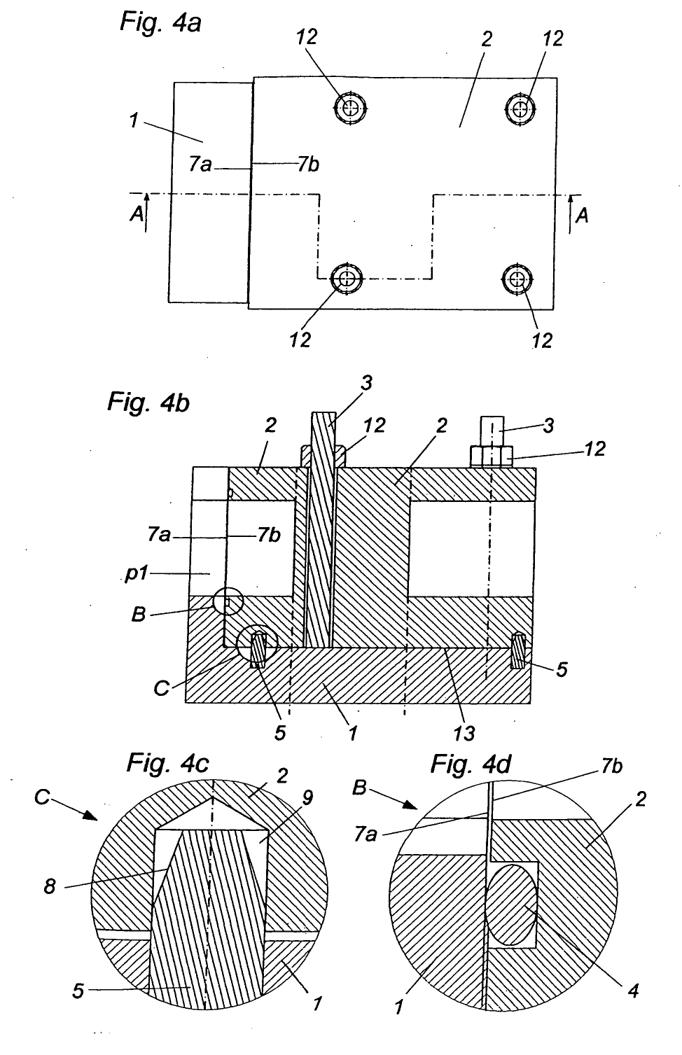

FIGS. 4a, 4b, 4c, 4d show similar views from FIGS. 2a to 2d in subsequent assembly steps, and

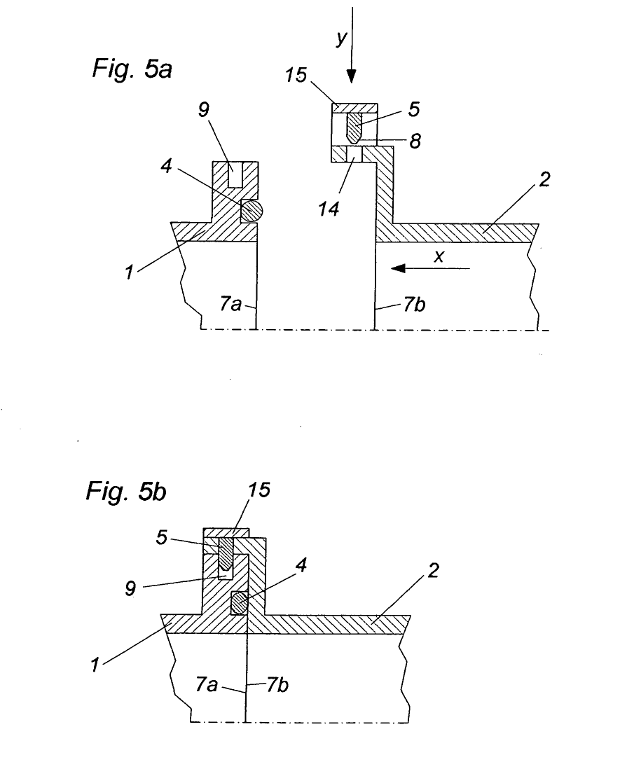

FIGS. 5a and 5b show a variant according to the invention by means of a pipe connection.

FIG. 1a shows a solution for connecting two components in accordance with the state of the art. A first workpiece 1 is to be sealingly connected to a second workpiece 2. Provided for that purpose is a guide element 3 which is fixedly connected to the first workpiece 1. The second workpiece 2 is axially displaced on that guide element 3, whereby the sealing means 4 can disadvantageously be sheared off, by virtue of the fact that the two components 1, 2 are disposed in closely adjacent relationship. A further disadvantage arises out of the use of excessively long guide elements 3 which in addition have to be of a very massive structure. Furthermore a comparatively large amount of installation space is required, which prevents the arrangement from being of a compact structural configuration.

FIG. 1b shows a further solution in accordance with the state of the art. The component 2 is pushed from above on to the pins 5 which, in the pushed-in condition of the component 2, prevent it from slipping laterally. It is also possible to see here the disadvantage of the large amount of structural space 6 which must be at least rather more than the height of the pins.

FIGS. 2a to 2d show a diagrammatically illustrated embodiment of the arrangement according to the invention for sealingly and releasably connecting two workpieces 1, 2, by reference to the assembly procedure for a cylinder head, in a first assembly step. FIG. 2a shows a plan view of the arrangement with a first workpiece 1, a second workpiece 2 to be connected, and a guide device 3. FIG. 2b shows a diagrammatic view in section taken along line A-A in FIG. 2a, from which the mode of operation of the arrangement will be understood. The first workpiece 1 has a guide device 3—here in the form of a cylindrical bar—which is fixedly connected to the first workpiece 1 and on which the second workpiece 2 is axially displaced. The two sealing surfaces 7a, 7b of the workpieces 1, 2 are of a substantially flat nature. Preferably at least one workpiece 1, 2 has a seal 4 which projects beyond the sealing surface 7b prior to assembly, as can be seen in the detail B in FIG. 2d.

In accordance with the invention it is now provided that the first workpiece 1 has at least one guide projection 5 which is arranged in parallel relationship with the sealing surface 7a of the first workpiece 1. That cylindrical guide projection 5 has a conical tip with an inclined surface 8 which, in the assembly procedure, engages into a provided opening 9 or engages against the edge 10. The inclined surface 8 is preferably inclined at between 10° and 45°. The basic idea of the invention advantageously provides that the second workpiece 2 can first be guided axially in spaced relationship with the sealing surface 7a of the first workpiece 1 by way of the guide device 3 (Y-component of movement) and can only then be pressed against the sealing surface 7a of the first workpiece 1 by sliding along the inclined surface 8 (X- and Y-components of movement). So that it is possible for the two workpieces 1, 2 to be pushed together, a lateral clearance 11 is advantageously provided between the guide device 3 and the second workpiece 2; in the illustrated embodiment the clearance 11 is embodied by a through bore which passes through the workpiece 2 and the diameter of which is larger than that of the guide device 3.

FIGS. 3a to 3d show the arrangement in a subsequent assembly step similarly to the views of FIGS. 2a to 2d. The workpiece 2 slides further and further along the inclined surface 8 by virtue of the force of gravity, whereby the seal 4 of the second workpiece 2 comes into contact with the first workpiece 1 (FIG. 3d).

FIG. 4a to 4d show the arrangement according to the invention in an assembled condition. In illustrated FIG. 4d, the seal 4 is subjected to pressure to such an extent that sealing integrity is afforded between the pressure p1 and ambient pressure. In that situation the cylinder head sealing gasket 13 in FIG. 4b is also subjected to a high pressure. It is advantageously now provided that there is at least one, preferably metric, screwthread provided on the guide device 3. In that way the guide device 3 can be advantageously subjected to the effect of an axially acting force by a clamping device, preferably a screw nut 12, and the workpiece 2 can thus be fixed in the pressed position with the workpiece 1.

FIGS. 5a and 5b respectively show a variant of the invention by reference to a connection between two pipes 1, 2 in a disassembled and an assembled condition respectively. The components are respectively arranged in mirror image relationship about the axis of symmetry, which means that there are respectively two guide projections 5, two openings 9 and two bores 14. Only one connecting arrangement is shown for the sake of improved clarity of the drawing. The pipes 1, 2 are pushed together in the direction X until the pipe 2 abuts against the seal 4 which in the unpressed condition projects beyond the sealing surface 7a. The clamping element 15 is then drawn together and the conical guide projections 5 penetrate into the openings 9 in the direction Y by way of the bore 14. The conical guide projection 5 penetrates into the opening 9 in the form of a blind bore or engages with the inclined surface 8 against the edge of the opening 9 and in so doing causes the two sealing surfaces 7a, 7b to be pressed together. In that situation the seal 4 is subjected to pressure to such an extent until the sealing function is achieved.

It will be appreciated that the arrangement according to the invention for sealingly and releasably connecting two workpieces is not limited to the embodiments by way of example illustrated in the drawing nor is it to be restricted by them. For example it is also possible to envisage a reversed kinematic solution in respect of the guide projections, which provides an opening on the first workpiece and the guide projections on the second workpiece.

1. An arrangement for sealingly and releasably connecting a first workpiece to a second workpiece, wherein each workpiece has at least one sealing surface, and wherein the first workpiece has at least one guide projection by which the sealing surfaces of the two workpieces can be pressed together by way of at least one inclined surface in the assembly procedure.

2. An arrangement according to claim 1, wherein the first workpiece and the second workpiece are two flanges.

3. An arrangement according to claim 1, wherein the inclined surface is provided on the guide projection, wherein the guide projection has a conical tip.

4. An arrangement according to claim 1, wherein the guide projection has a cylindrical perimeter.

5. An arrangement according to claim, wherein in the assembly procedure the guide projection engages into an opening or against an edge of the second workpiece.

6. An arrangement according to claim 5, wherein the opening has the form of a blind bore.

7. An arrangement according to claim 5, wherein the inclined surface is provided at the opening or at the edge.

8. An arrangement according to claim 1, wherein the sealing surfaces are of a substantially flat nature.

9. An arrangement according to claim 1, wherein the at least one guide projection is arranged in parallel relationship with the sealing surface of the first workpiece.

10. An arrangement according to claim 1, wherein the inclined surface is inclined at between 10° and 45°.

11. An arrangement according to claim 1, wherein a guide device of the first workpiece is arranged parallel to the sealing surface.

12. An arrangement according to claim 11, wherein the guide device of the first workpiece is a cylindrical bar.

13. An arrangement according to claim 11, wherein a lateral clearance is provided between the guide device and the second workpiece.

14. An arrangement according to claim 11, wherein the guide device is fixedly connected to the first workpiece.

15. An arrangement according to claim 1, wherein at least one workpiece has a seal.

16. An arrangement according to claim 15, wherein prior to assembly said seal projects beyond the sealing surface.

17. An arrangement according to claim 1, wherein the second workpiece can firstly be guided in spaced relationship with respect to the sealing surface of the first workpiece and can only then be pressed against the sealing surface of the first workpiece by sliding along the at least one inclined surface.

18. An arrangement according to claim 11, wherein a screwthread is provided at least partly on the guide device.

19. An arrangement according to claim 11, wherein the guide device can be acted upon by an axially operative force by a clamping device.

20. An arrangement according to claim 19, wherein the damping device is a screw nut.

21. A method of sealingly and releasably connecting a first workpiece to a second workpiece, wherein the two workpieces are moved in spaced relationship relative to each other and are pressed together by way of at least one inclined surface transversely with respect to the direction of movement only in the last assembly phase.
